(19) United States
(12) Patent Application Publication
(10) Pub. No.: US 2004/0247319 A1
(43) Pub. Date: Dec. 9, 2004

(54) Characterization of a transmission path of an optical signal having an optical communication signal

(76) Inventor: Paul Melman, Newton, MA (US)

Correspondence Address: PERMAN & GREEN, 425 POST ROAD, FAIRFIELD, CT, 06824, US

(21) Appl. No.: 10/491,820

(22) PCT Filed: Oct. 16, 2002
(86) PCT No.: PCT/IB02/05811

Related U.S. Application Data
(60) Provisional application No. 60/345,897, filed on Nov. 9, 2001.

(51) Int. Cl. H04J 14/06

(52) U.S. Cl. 398/65; 398/25

(57) ABSTRACT

For deriving a transmission value representing a property of a transmission path of an optical signal having at least one optical communication signal, a converter is provided for converting the optical signal, or at least a part thereof, into an electrical signal. An electrical filter at least substantially removes spectral components resulting from the at least one optical communication signal from the converted electrical signal. An analyzer derives the transmission value from the filtered converted electrical signal.

### BACKGROUND OF THE INVENTION

The present invention relates to the characterization of a transmission path of an optical signal.

The economics of optical networks favors the use of DWDM technology where many wavelengths propagate simultaneously in a single fiber. At high bit rates, conversion of optical signal to electronic equivalent is very costly and therefore the goal is to maintain the signal in the optical domain from origin to destination. This means that only optical amplification is used between network nodes. Optical amplifiers, by their nature add spontaneous emission to the amplified signal. At the receiver, a photo-detector converts the optical signal to electronic form for further processing. In the process of conversion, the spontaneous emission of the amplifiers combines with the optical signal and generates noise. In optically amplified networks, this is the dominant noise source and is the main contributor to higher bit-error-rate (BER). The amount of spontaneous emission added to the transmission channel depends on the operating conditions of the line amplifiers and the number of amplifiers in signal's path.

Since the level of amplified spontaneous emission (ASE) power contained in an optical communication channel is usually masked by much stronger optical signal, it is known in the art to measure the level of ASE outside and on both sides of the communication channel and interpolate between these two values to estimate the ASE level at the center of the channel. This method is quite accurate in simple cases where the channel density is low enough to allow such measurement and all channels travel over the same segment of the network and undergo amplification in the same chain of amplifiers. This is the case for single wavelength systems (SONET) or sparsely populated, point-to-point DWDM systems (i.e. for channel spacing of 200 Ghz).

For channel spacing of 100 Ghz and less, the measurement of ASE by extrapolation becomes increasingly less accurate. Furthermore, economical deployment of networks favors mesh topologies where optical channels may travel through different routes making this method less useful. Prior art methods are implemented using a variety of technologies such as: miniaturized optical spectrum analyzers, bulk gratings, tunable fiber Bragg gratings, tunable Fabry-Perot filters, or array waveguide gratings.

In the case of dense DWDM systems or switched mesh networks, where different channels may undergo a different number of amplification stages, and thus contain different power levels of spontaneous emission, the ASE power level outside and adjacent to channel does not reflect the ASE power level inside the channel, and thus must be measured directly rather than through interpolation.

U.S. Pat. No. 6,433,864 (Chung et al.) discloses monitoring optical signal-to-noise ratio (OSNR) of optical WDM optical transmission systems. Monitoring the OSNR in high speed networks is described e.g. in the articles: “Spectral Monitoring of OSNR in High-Speed Networks” by D. C. Kilper, S. Chandrasekhar, L. Bu hi, A. Agarwal, and D. Maywar, Lucent, and “OSNR Monitoring for Fault Management in High-Speed Networks” by W. Weingartner and D. C. Kilper, Lucent. ECOC, 2002, 7.4.4

The so-called Polarization-Nulling Method, as disclosed e.g. in U.S. Pat. No. 5,223,705 (Aspell et al.), has also been employed for OSNR monitoring purposes, as described e.g. in the articles: “OSNR Monitoring Technique using Polarization-Nulling Method” by J. H. Lee, D. K. Jung, C. H. Kim, and Y. C. Chung in IEEE Photonics Technology Letters, Vol. 13, No. 1, January 2001, and in “An Improved OSNR Monitoring Technique based on Polarization-Nulling Method” by J. H. Lee and D. K. Jung, Korea Advanced Institute of Science and Technology OFC 2001, T*uP6-1.

Monitoring of the level of spontaneous emission in an optical channel provides an optical measure directly related to BER. Furthermore, in high bit-rate and long haul fiber links, polarization mode dispersion and non-linear effects in the fiber distort the shape of an optical pulse. Polarization mode dispersion (PMD) refers to the phenomena where different polarization states propagate in a fiber at different velocities, thus changing the shape of the pulse according to its local polarization state. Non-linear effects are the consequence of the high optical power in the fiber. The high power locally changes the index of refraction of the glass fiber thereby creating local changes in propagation velocity. This phenomenon again leads to local pulse distortion. The pulse distortions described here lead eventually to errors in detection of ones and zeroes in digital systems (in analog systems it leads to the degradation of signal quality). This error-generating mechanism is not captured by detection of spontaneous emission alone.

### SUMMARY OF THE INVENTION

It is an object of the invention to provide an improved measurement of optical transmission channels. The object is solved by the independent claims. Preferred embodiments are shown by the dependent claims.

According to the present invention, a transmission value (representing a property of a transmission path of an optical signal having at least one optical communication signal) is derived by converting the optical signal, or at least a part thereof, into an electrical signal. An electrical filter is provided for at least substantially removing spectral components resulting from the at least one optical communication signal from the converted electrical signal, and the transmission value is then derived from the filtered converted electrical signal. The transmission value is preferably derived from a measured spectral power density of the filtered converted electrical signal.

The transmission value might be at least one of a group comprising: a noise value representing an amount of noise present in the transmission path, a PMD value representing an amount of polarization mode dispersion present in the transmission path, a non-linear effect value representing an amount of non-linear effects present in the transmission path, an optical signal to noise ratio as a ratio of intensities between the at least one optical communication signal and a noise value representing an amount of noise present in the transmission path.

In one embodiment, a first optical filter is applied for at least substantially removing the at least one optical communication signal from the optical signal. Such first optical filter might comprise a polarization separation unit for at least substantially removing a polarized portion of the at least one optical communication signal from the optical signal. The polarization separation unit preferably comprises a polarization controller for altering a polarization state of the at least one optical communication signal to a defined polarization state and at least substantially removing components of the optical signal having the defined polarization state. The aforementioned polarization nulling techniques might be applied for that purpose. In one embodiment, the polarization separation unit comprises a polarization control device for transforming an arbitrary input state of polarization in the optical signal to a linearly polarized light, and a polarizer crossed with the plane of linear polarization of the output of the polarization control device.

In another embodiment, a second optical filter provides for at least substantially separating the at least one optical communication signal from other signals and for providing the separated signal as the optical signal. Such second optical filter might comprise a demultiplexer for demultiplexing the at least one optical communication signal as the optical signal. In case at least one optical communication signal is a DWDM channel in a multi-channel stream of the optical signal, the demultiplexer can be provided for demultiplexing the DWDM channel from the multi-channel stream.

In a further embodiment, the electrical filter provides the filtered converted electrical signal the portion of the converted electrical signal in a spectral range between at least substantial spectral components resulting from the at least one optical communication signal and a DC offset of the converted electrical signal. Preferably, the spectral range is selected in a range dominated by amplified spontaneous emission or in a range wherein contributions of amplified spontaneous emission dominate over contributions from at least one of: polarization mode dispersion and spectral components resulting from the at least one optical communication signal.

In a preferred embodiment, first a noise value (representing an amount of noise present in the transmission path) is determined from the filtered converted electrical signal. A spectral unit is provided for deriving values of intensity for a plurality of different spectral points in the spectrum of the converted electrical signal, and a PMD value (representing an amount of polarization mode dispersion present in the transmission path) is derived for one or more of the plurality of different spectral points by subtracting the noise value from the derived values of intensity. An approximation of a spectral course (or curve) of polarization mode dispersion of the transmission path might further be derived by applying one or more of the derived PMD values in a model describing an expected spectral course (or curve) of polarization mode dispersion. Preferably, the expected spectral course of polarization mode dispersion is assumed to be at least substantially proportional to 1-cos(ω*τ), where ω is the frequency of the converted electrical signal and τ is the differential group delay of the transmission path.

To measure the ratio of signal power to the amplified spontaneous emission (ASE) power contained e.g. in an optical communication channel, preferred embodiments of the present invention take advantage of a model assuming a difference in optical spectral characteristics of the signal as compared with the ASE. The spectrum of an optical signal can be usually determined by transmission rate and might be roughly equal to the bit rate in Hertz. Thus e.g. a 10 Gbit/sec channel occupies approximately a spectral slice of 10 GHz. In contrast the ASE might extend over many Terahertz.

A preferred embodiment relates to in-channel monitoring of amplified spontaneous emission e.g. in fiber optic networks. In the presence of an optical signal, the spontaneous emission is measured at the signal wavelength band by first applying an optical filter, which is centered on the wavelength of the optical channel. Subsequently a polarization control device converts the polarization state of the optical signal to a linear state. A photo-detector then converts the optical signal to electrical signal. The electrical signal is subsequently analyzed as to its spectral content in order to separate the contribution to the photocurrent caused by the depolarized part of the signal, from the photocurrent caused by any unpolarized part of the optical signal.

Following the model of the invention, the photocurrent spectrum generated by the spontaneous emission peaks at low frequencies with spectral shape determined by the shape of the optical filter. The shape of the part of the optical signal which is depolarized by PMD can be assumed to be similar to the optical signal itself multiplied by a 1-cos(ω*τ) function and its spectrum extends over the full signal bandwidth. Its contribution to the low frequency part of the converted electrical spectrum (here e.g. radio frequency—RF—spectrum) is small and flat providing a converted electrical spectral signature, which permits separation the two contributions. Also other contributions with a distinct spectral signature can be determined from the converted electrical spectral analysis. These contributions can include linear or nonlinear elements or crosstalk from adjacent channels.

In one embodiment, an in-channel noise detection is provided to distinguish between modulated laser power versus noise such as amplified spontaneous emission added e.g. by in-line amplifiers. This embodiment makes use of a model of the spectral characteristic of the PMD modified depolarization component. In this model, the spectral characteristic of the PMD degree of depolarization, e.g. as seen at the output of the polarization controller, can be regarded as being substantially proportional to 1-cos(ω*τ), where ω is the (e.g. RF) frequency of the opto-electro-converted signal and τ is the DGD of the system fiber. By performing power measurement away from the DC spectral component but instead at low frequencies (preferably about 100 kHz to a few MHz, such as tens to hundreds of MHz) so that ω*τ is small compared to unity, the effect of the depolarizing system PMD can be eliminated making the technique useful in real network environment. Furthermore, the PMD contribution to the depolarization components allows to provide means to measure system PMD e.g. in a simple and low cost manner.

Further details about noise figure measurements and in particular OSNR measurements can also be obtained from the book by Dennis Derickson, “Fiber Optic Test and Measurement, Prentice Hall Inc., ISBN 0-13-534330-5, 1998, the teaching thereof shall be incorporated herein by reference.

Preferred embodiments of the present invention, in addition to providing a true measure of spontaneous emission level, also provide a measure of PMD, adjacent channel crosstalk, and optical non-linearities in the system fiber.

Preferred embodiments of the present invention allow to measure and monitor directly, without interpolation, the ASE power level contained inside the optical channel even in the presence of PMD and non-linear effects in the fiber. Furthermore, preferred embodiments allow monitoring the magnitude of non-linear effects.

In one embodiment, it begins with demultiplexing of one or more DWDM channels from the multi-channel stream in an optical fiber using one of the methods described herein. The first step in the analysis is determination of the channel degree of polarization (DOP). This is performed by application of a polarization control device, which transforms the arbitrary input State of Polarization (SOP) to a linearly polarized light at the output. The DOP is measured using a polarizer crossed with the plane of linear polarization of the output of the polarization control device. The light beam that passes the cross polarizer contains half of the power of the ASE and contributions from PMD and other distortions.

In this embodiment, the next step in signal processing takes advantage of the spectral difference between the ASE component of the crossed polarized (relative to the polarizer) beam and all other components of this part of the beam. This additional signal-processing step permits an unambiguous identification of the ASE and other noise mechanisms in a communication channel. For example the spontaneous emission power density spectrum peaks at 0 frequency (DC) and drops gradually away from the dc level. In contrast, the spectrum of the residual signal, PMD and other distortion components exhibit a narrow spike at 0 frequency (average signal power) followed by a wide gap in power density, before the signal power becomes significant. The functional shape of the PMD power density function can be approximated to 1-cos(ω*τ) multiplied by the signal spectral density, where ω is the frequency at which power is measured and τ is the total system differential group delay. Thus measurement of optical power density at converted electrical frequencies within this gap (the low frequency part of the signal spectrum) provides an accurate measure of the ASE power substantially uncorrupted by PMD.

Other preferred embodiments allow monitoring the degree of signal distortion induced by propagation of optical pulses through the optical fiber. To monitor the degree of signal distortion, the extinction ratio (or the DOP) of the linear polarization generated by the polarization controller is monitored together with the converted electrical frequency values at selected frequencies. Distortion of modulated signal by polarization mode dispersion can be then measured by comparing the DOP value to that measured at the converted electrical frequencies. Departures from the approximated 1-cos(ω*τ) functional shape are than a measure of other signal distortions.

Distortion of modulated signal by non-linear effects in the fiber reduces the degree of polarization measured on a time-averaged basis. For example, DOP depends on the differential group delay (DGD) in the fiber. Since the DGD is continuously varying in a communication link, the DOP is a time varying parameter. For a given fiber link, its average value, after subtraction of the ASE contribution, is a measure of the degree of pulse distortion in a system. Further preferred embodiments allow monitoring the degree of signal distortion in each channel due to non-linear effects only. This method separates the degree of signal distortion into linear and non-linear contributions. To monitor the non-linear contribution to the optical signal distortion, the average DOP is monitored as a function of optical power. As optical channels are added to the optical link or individual channel power increased the total power in the fiber increases and magnitude of non-linear effect increases. Continuous monitoring of the nonlinear component allows the network operator to set limits on the number of channels or on the power per channel transmitted.

The invention can be partly or entirely embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIG. 1 illustrates an in-channel optical performance monitoring system.

FIG. 2 graphically illustrates photocurrent spectral power density of the amplified spontaneous emission (A) and the depolarized signal power (B) at port 142 of FIG. 1.

### DETAILED DESCRIPTION OF PREFERRED EMBODIMENTS OF THE INVENTION

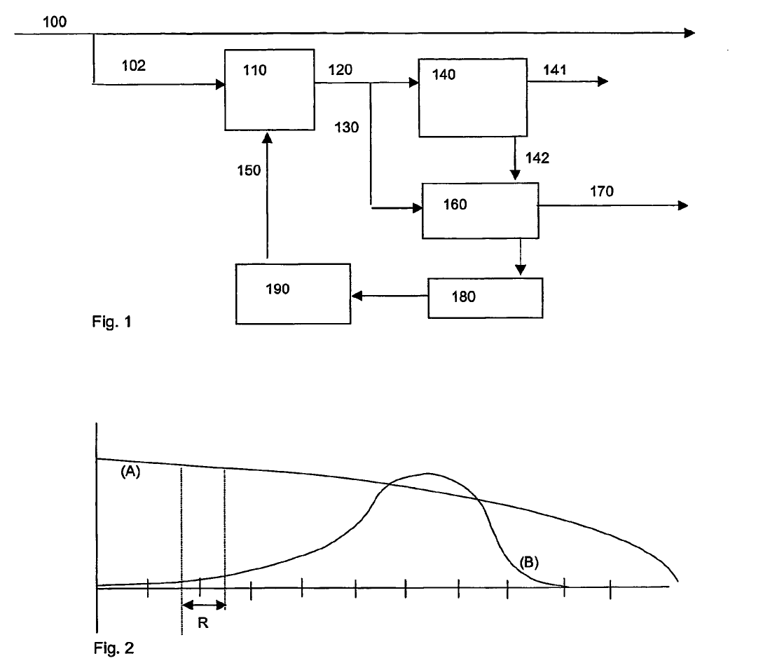

FIG. 1 is a block diagram of the in-channel performance monitoring system. The multi-wavelength optical signal in the optical network fiber 100 is tapped, e.g. by a fiber coupler 102. In applications where the system is used in qualification of installed networks, the signal is received at the end of a line and the tap need not be used. In both cases the signal is directed to an optical filter 110 where only one channel is transmitted to its output 120. The optical filter can be a fixed filter and can be made e.g. by thin film deposition, with a fiber Bragg grating or etalons. The optical filter 110 can be also made using tunable filters such as tunable Fabry-Perot filters made by microfabrication (MEMS) technology, or polished fiber technology, tunable fiber Bragg gratings, sliding thin film filter bars, or moveable diffraction gratings. The output 120 of all of these devices is a single wavelength single channel optical signal. This optical signal includes the information-carrying optical power generated by a transmitting laser and the amplified spontaneous emission power generated by optical amplifiers in the fiber optic link.

A tap 130 is used to monitor the total power in the channel. The rest of the filtered optical power is directed to a polarization control system 140. The polarization controller converts the arbitrarily polarized input signal into a linearly polarized beam. The polarization controller has two outputs at the two ports of a polarization beam splitter. The part of the beam comprising the linearly polarized signal propagates along the transmitting direction of the polarization beam splitter and exits port 141 of the polarization controller onto a photodetector.

The second part of the light signal includes all components of the optical beam which were not aligned by the polarization controller along the main direction. This output 142 contains one half of the power of the amplified spontaneous emission as well as contributions from the depolarized parts of the main signal. In order to separate the amplified spontaneous emission from the depolarization components an electronic filter 160 is used to analyze the photocurrent spectral content of the detected light at the output port 142.

FIG. 2 shows (Spectral Power Density vs. Frequency) a typical example of the Amplified Spontaneous Emission spectrum A and spectrum B showing the part of the signal that has been depolarized by PMD. Spectrum A peaks at low frequencies and diminishes in magnitude at higher frequencies. In contrast the spectrum of the depolarized (by PMD) portion of the signal B extends over the full signal bandwidth, independent of the optical filter shape 110. As an example, curve B might peak at about 5-10 GHz. The largely differing spectral signatures are used here to separate the spontaneous emission contribution A from the contributions from the depolarized portion of the signal B. Any contributions to the photocurrent spectra with distinct spectral signature such as linear or non-linear cross talk can also be separated by analysis of the photocurrent spectra.

When a tunable optical filter is used to select the monitored power, a control electronic board 180 is used to sequentially select the monitored optical channel. This board receives signal from the electronic filter board 160 indicating that the measurement has been completed. The control electronics 180 sends a signal to the optical filter driver 190 to readjust its center frequency to the next optical channel. The process repeats again for the next channel. The results of the spectral and power measurements are transmitted through port 170 to the network control center.

To derive the in-channel noise value in the presence of network impairments, such as PMD and cross-talk, a number of measurements can be performed. The first measurement is of the total signal power at tap 130. This number is stored for further processing. The second set of measurements is performed at the output of the polarization controller 140. This port includes one half of all unpolarized radiation in the fiber in addition to depolarized parts of the optical signal.

Turning again to FIG. 2, measurement of the intensity of the converted electrical power (e.g. at about 100 kHz to tens or hundreds of MHz) in a measuring range R (preferably with a narrow measurement bandwidth of about 10 KHz) provides a measure of ASE since it is directly proportional to its average power. This embodiment of the current invention makes use of the power spectral distribution of the PMD distortion B, which does not interfere with this measurement A at low frequencies. Computing the ratio of the ASE power to the signal power (measured at tap 130) provides a noise figure for the system, as also explained in detail in the aforementioned book by Derickson

Additional information can be obtained from the converted electrical analysis in the following manner. To measure the PMD of the system, the DC component of the spectral distribution is measured in addition to the converted electrical power. In absence of PMD, this value can be regarded as a direct measure of the power in the amplified spontaneous emission and thus must agree with the converted electrical measurement. In presence of PMD this agreement no longer holds and the difference between this measurement and the converted electrical measurement is a measure of PMD in the system.

Other embodiments also provide means to separate the contribution of the PMD distortion from other distortions and crosstalk. For example, measurement of the converted electrical power at a number of frequencies provides an independent way to measure PMD. This is possible because the PMD modified depolarized component of the signal can be approximated by a 1-cos(ω*τ) multiplied by the signal spectrum (as about shape B in FIG. 2). Comparison of that measurement with the DC measurement of the spectrum provides a measure of additional depolarizing components in the system.

While the polarization control system 140 can be any as known in the art, preferably a fast polarization controller based on polarization modulation is used as disclosed in the pending International Patent Application (applicant's internal reference number: 1002-0989-2) by the same applicant, the teaching of that document with respect to polarization controller (in particular FIG. 34 and accompanying description) shall be incorporated herein by reference, wherein the monitoring photodetector 50 of that document corresponds to reference number 142 of the present application.

1. An apparatus for deriving a transmission value representing a property of a transmission path of an optical signal having at least one optical communication signal, comprising:
a converter adapted for converting at least a part of the optical signal into an electrical signal,
an electrical filter adapted for at least substantially removing spectral components resulting from the at least one optical communication signal from the converted electrical signal, and
an analyzer adapted for deriving the transmission value from the filtered converted electrical signal.

2. The apparatus of claim 1, further comprising a first optical filter adapted for at least substantially removing the at least one optical communication signal from the optical signal.

3. The apparatus of claim 2, wherein the first optical filter comprises a polarization separation unit adapted for at least substantially removing a polarized portion of the at least one optical communication signal from the optical signal.

4. The apparatus of claim 3, wherein the polarization separation unit comprises a polarization controller adapted for altering a polarization state of the at least one optical communication signal to a defined polarization state and at least substantially removing components of the optical signal having the defined polarization state.

5. The apparatus of claim 3, wherein the polarization separation unit comprises:
a polarization control device adapted for transforming an arbitrary input state of polarization in the optical signal to a linearly polarized light, and
a polarizer crossed with the plane of linear polarization of the output of the polarization control device.

6. The apparatus of claim 1, further comprising a second optical filter adapted for at least substantially separating the at least one optical communication signal from other signals and for providing the separated signal as the optical signal.

7. The apparatus of claim 6, wherein the second optical filter comprises a demultiplexer adapted for demultiplexing the at least one optical communication signal as the optical signal.

8. The apparatus of claim 7, wherein at least one optical communication signal is a dense wavelength division multiplexing (DWDM) channel in a multi-channel stream of the optical signal, and the demultiplexer is adapted for demultiplexing the DWDM channel from the multi-channel stream.

9. The apparatus of claim 1, wherein the electrical filter (160) is adapted for providing as the filtered converted electrical signal the portion of the converted electrical signal in a spectral gap between at least substantial spectral components resulting from the at least one optical communication signal and a DC offset of the converted electrical signal.

10. The apparatus of claim 9, wherein the spectral gap is selected in a range dominated by amplified spontaneous emission.

11. The apparatus of claim 9, wherein the spectral gap is selected in a range wherein contributions of amplified spontaneous emission dominate over contributions from at least one of: polarization mode dispersion and spectral components resulting from the at least one optical communication signal.

12. The apparatus of claim 1, wherein the analyzer derives the transmission value from a measured intensity of the filtered converted electrical signal.

13. The apparatus of claim 1, wherein the transmission value is at least one of a group comprising: a noise value representing an amount of noise present in the transmission path, a PMD value representing an amount of polarization mode dispersion present in the transmission path, a non-linear effect value representing an amount of non-linear effects present in the transmission path, an optical signal to noise ratio as a ratio of intensities between the at least one optical communication signal and a noise value representing an amount of noise present in the transmission path.

14. The apparatus of claim 13, wherein the apparatus is adapted to derive as a first transmission value a noise value representing an amount of noise present in the transmission path, and as a second transmission value a polarization mode dispersion (PMD) value representing an amount of polarization mode dispersion present in the transmission path, the apparatus further comprising:
a first analyzer adapted for deriving the noise value from the filtered converted electrical signal,
a spectral unit adapted for deriving values of spectral power density for a plurality of different spectral points in the spectrum of the converted electrical signal, and
a second analyzer adapted for deriving a PMD value for one or more of the plurality of different spectral points by subtracting the noise value from the derived values of intensity.

15. The apparatus of claim 14, wherein the second analyzer further comprises an approximation unit adapted for approximation a spectral course or curve of polarization mode dispersion of the transmission path by applying one or more of the derived PMD values in a model describing an expected spectral course or curve of polarization mode dispersion.

16. The apparatus of claim 15, wherein the model describes the expected spectral course or curve of polarization mode dispersion as being at least substantially proportional to 1-cos(ω*τ), where ω is the frequency of the converted electrical signal and τ is the differential group delay of the transmission path.

17. A method for deriving a transmission value representing a property of a transmission path of an optical signal having at least one optical communication signal, comprising:
converting at least a part of the optical signal into an electrical signal,
at least substantially removing spectral components resulting from the at least one optical communication signal from the converted electrical signal,
deriving the transmission value from the filtered converted electrical signal.

18. An optical measurement device for a communication network comprising:
an optical channel;
a polarization controller that alters a polarization state of an optical signal from the optical channel to provide a converted optical signal;
a detector that detects the converted optical signal; and
an analyzer that receives a signal from the detector and separates spectral components of the signal.
